(19) United States
(12) Patent Application Publication
(10) Pub. No.: US 2014/0332217 A1
(43) Pub. Date: Nov. 13, 2014

(54) PORTLAND SAUDI CEMENT TYPE-G WITH NANOSILICA ADDITIVE FOR HIGH PRESSURE-HIGH TEMPERATURE APPLICATIONS

(71) Applicants: KING ABDULAZIZ CITY FOR SCIENCE AND TECHNOLOGY, RIYADH (SA); KING FAHD UNIVERSITY OF PETROLEUM AND MINERALS, DHAHRAN (SA)

(72) Inventors: MUHAMMAD KALIMUR RAHMAN, DHAHRAN (SA); SAMI ABDULKAREM AMER, DHAHRAN (SA); ABDULAZIZ ABDALLA AL-MAJED, DHAHRAN (SA)

(73) Assignees: KING ABDULAZIZ CITY FOR SCIENCE AND TECHNOLOGY, RIYADH (SA); KING FAHD UNIVERSITY OF PETROLEUM AND MINERALS, DHAHRAN (SA)

(21) Appl. No.: 13/953,699

(22) Filed: Jul. 29, 2013

Related U.S. Application Data
(60) Provisional application No. 61/822,816, filed on May 13, 2013.

(51) Int. Cl. C09K 8/467

(52) U.S. Cl. CPC C09K 8/467
USPC 166/293; 106/737

(57) ABSTRACT

The Portland Saudi cement type-G with nanosilica additive for high pressure-high temperature applications comprises a mixture of about 1.0%-2.0% by dry weight of nanoparticles of silica; and type-G Portland Saudi cement forming the balance of the mixture. The cement so formed is suitable for use in deep petroleum wells, which require cement that can be introduced under high temperature (about 290° F.) and high pressure (about 8,000-9,000 psi) conditions. The addition of nanosilica shortened the thickening time for the cement slurry and caused a growth in the average compressive strength of the cement samples. In addition, the nanosilica did not cause any free water separation from the cement slurry column after aging.

### CROSS-REFERENCE TO RELATED APPLICATIONS

This is application claims priority to U.S. Provisional Application Ser. No. 61/822,816 filed May 13, 2013, the disclosure of which is incorporated herein by reference in its entirety.

### BACKGROUND OF THE INVENTION

1. Field of the Invention

The present invention relates to cement, and particularly to Portland Saudi cement type-G with nanosilica additive for high pressure-high temperature applications.

2. Description of the Related Art

Oil and gas are considered the most important sources of energy worldwide. Obtaining this energy requires drilling thousands of wells yearly for exploration and production. Once oil or gas is found, a production strategy is planned to extract this source of energy efficiently. This involves drilling the wells as well as completing them for production and maintaining them in the future. Normally, drilling operations require running steel casing/liner into the well to support the well bore from any collapse that could occur during drilling, and also to minimize underground formation damage from drilling fluids. However, these tools must be cemented to hold in place and provide integrity to the well bore.

Cement is used in drilling operations to serve several purposes, such as casing protection and support, prevention of movement of fluids behind the casing, prevention of fluid entry from high permeability formations, abandoning unneeded wells, and other purposes. Cement slurry is placed in the well by mixing cement powder with water at the surface before pumping it hydraulically to the desired location.

During any cementing job, cement slurry properties and characteristics should meet the job requirements in terms of time and cost. Furthermore, the cement slurry must remain pumpable long enough to allow placement, and also must have enough density to overbalance the underground formation pressure. The cement slurry should also be environmentally friendly and should not cause damage or contamination to underground formations.

Oil and gas wells vary in terms of depths, downhole pressure (up to 30,000 Psi for very deep gas wells), and temperature (up to 500° F. for deep wells). Because of this wide range of depths, pressure, and temperature, cement mixtures should be designed carefully.

Cementing operations involve preparation of an optimum design of the cement slurry, which includes proper amounts of cement powder with the proper amount of water, which is used to provide the fluidity of the mixture.

At the present time, numerous types of additives are used in the oil/gas well cementing industries, including accelerating additives, lightweight additives, heavyweight additives, retarders, loss circulation control agents, filtration control agents, friction reducers, expanding additives, silica and others.

The petroleum industry encounters several challenges in different areas and needs more research to yield improvements and developments. One of the most difficult challenges associated with drilling and completion operations is assuring good cementing jobs. Poor cementing jobs could result in serious consequences that may jeopardize the success of any oil and gas well.

Communications between zones, gas migration, undesired fluid entry to the well bore, and casing corrosion are examples of serious consequences resulting from poor cementing jobs. Both private companies and academia are continuously conducting research projects to improve and develop new cements and chemical additives that enhance cementing oil and gas wells in various environments.

Silica products were introduced a long time ago and have been used in several fields that require cementing operations. Their ability to improve cement properties and to sustain cement strength in high temperature applications has made them a favorable mixture with cement.

Concrete is prepared and used at surface normal pressure and temperature, where properties such as compressive/tensile strengths are crucial. However, in oil/gas well applications, cement slurry is subjected to a harsh environment where the temperature and pressure are much higher than those in normal concrete applications. Since the cement slurry is pumped into the wellbore, such issues as thickening time, rheology, water loss, development of slurry strength with time, cement shrinkage, and formation damage are matters of as much, if not more concern than high compressive strength developed after set.

A cement system is defined as the cement slurry design consisting of different materials that are used to give certain properties for performance improvement. The cement system consists of three elements.

The first element of the cement system is cement powder (such as Portland cement), which is made up of chemical compounds (such as calcium silicate, as well as calcium aluminate and other oxide components. The cement powder is the main element of the cement system.

The second element of the cement system is water that is mixed with the cement powder to provide fluidity to the mixture, and also to act as a hydration agent to the cement. The amount of water must be optimized when added to the cement. The water to cement ratio must be carefully selected since low water to cement ratio results in high cement slurry viscosity and rate of set, while high water to cement ratio may cause free water separation and a reduction in cement density.

The third element of the cement system is the chemical additives, which assist cement system performance by adding desired properties to the cement.

There are a variety of cement types and classes used worldwide in different fields and applications. However, the petroleum industry has accepted the eight cement classes set by the American Petroleum Institute (API). The cement classes are designated by letters from A to H intended for certain job specifications. Portland Saudi cement type-G complies with API classification standards.

The performance of the cement system can be controlled by chemical additives. Thus, the cementing job can be conducted as desired. There are a wide range of chemical additives produced by different companies to meet petroleum industry requirements.

Density control agents are used to increase or decrease cement slurry density. Increasing cement slurry density is needed to overbalance formation pressure, preventing fluid flow from the formation to the wellbore. An excessive increase in cement slurry density may increase hydrostatic pressure higher than formation pressure, resulting in fluid loss into the formation, and sometimes undesired fractures. The most common density control additives are barite and hematite, which are considered as weighting agents to increase cement slurry density. The most common lightening weight agents are pozzolans and nitrogen.

Accelerators and retarders are used to control cement slurry thickening time during cementing operations. This is extremely important to make the cement slurry pumpable until it reaches its destination in the annular space between the formation and the steel casing. Accelerators are used for shallow, low temperature and pressure cement jobs, where a long thickening time is not necessary. Retarders are used for deep, high temperature and pressure cement jobs, where thickening time needs to be adequate to complete the cementing operation safely. The most commonly used accelerators are calcium chloride and sodium chloride, while the most commonly used retarders are calcium lignosulfonates and borax.

Fluid loss control agents are used to control the rate at which the slurry loses water and to maintain it within the acceptable industry standards. Controlling fluid loss rate is an important issue to be considered when cementing across permeable formations, where it could be damaged by the cement slurry filtrate. The most commonly used fluid loss control agents are organic polymers and cellulose derivatives.

There are different types of lost circulation control agents, granular type (e.g. Gilsonite), flake type (e.g. cellophane), and fibrous (e.g. nylon). Controlling lost circulation is an important issue to be considered when cementing across highly permeable and vuggy formations, as well as formations having natural or induced fractures. Lost circulation might be controlled by reducing cement slurry density and by adding additives to act as a plugging bridge on the opening area of the high permeability zone or the fracture.

Defoamers are used to minimize foaming problems and are normally used with every cement system. Cement foaming is one of the problems associated with the cement slurry while mixing. The entrapped air in the cement slurry could cause damage to the pumps in the field, and also could cause incorrect density readings, and consequently a mixture with incorrect cement slurry density. Defoamers are special additives developed by different companies and are available in powder or liquid form for convenient use.

Dispersants are used mainly to control cement slurry rheological properties for better mixing and pumping. They have the ability to reduce friction between cement slurry particles, resulting in a lower pumping pressure requirement, and also reducing water-to-cement ratio, which improves cement compressive strength. In addition, dispersants are used to create turbulent flow for improved mud removal from the wellbore. However, it has been noticed that dispersants have the tendency to make cement slurry thickening time longer, so it should be used with caution. Dispersants are special additives developed by different companies and are available in powder or liquid form for convenient use.

Expansion additives are used to give cement an expansion property to bond with the casing/liner, and to give integrity to the wellbore. Cement slurry is pumped downhole and placed in the annular space between the casing/liner and the formation. After cement set, the cement column may suffer from shrinkage due to the harsh environment downhole in terms of pressure and temperature. Cement expansion can provide better zonal isolation, minimize gas migration and fluid entry problems, and prolong the productivity of wells.

High temperature agents are added to the cement system to sustain compressive strength at high temperatures over a long period of time. Research and field practices have shown that cement under high temperature (>230° F.) tends to suffer from compressive strength retrogression, which consequently jeopardizes the productivity of the well. Silica products, such as silica flour and silica sand, are added to the cement system to sustain compressive strength at high temperatures over a long period of time.

Thus, Portland Saudi cement type-G with nanosilica additive for high pressure-high temperature applications solving the aforementioned problems is desired.

### SUMMARY OF THE INVENTION

The Portland Saudi cement type-G with nanosilica additive for high pressure-high temperature applications comprises a mixture of about 1.0%-2.0% by dry weight of nanoparticles of silica; and type-G Portland Saudi cement forming the balance of the mixture. The cement so formed is suitable for use in petroleum wells, which require cement that can be introduced under high temperature (about 290° F.) and high pressure (about 8,000-9,000 psi) conditions.

These and other features of the present invention will become readily apparent upon further review of the following specification and drawings.

### BRIEF DESCRIPTION OF THE DRAWINGS

FIG. 1 is a table showing the general formula for Portland Saudi cement type-G with nanosilica additive for high pressure-high temperature applications according to the present invention, together with predicted properties.

FIG. 2 is a table showing an exemplary formulation of Portland Saudi cement type-G without nanosilica additive according to the prior art, together with representative properties.

FIG. 3 is a table showing the general formula for Portland Saudi cement type-G with 2.0% nanosilica additive for high pressure-high temperature applications according to the present invention, together with representative properties.

FIG. 4 is a table showing fluid loss rate for Portland Saudi cement type-G with nanosilica additive for high pressure-high temperature applications according to the present invention for cement slurries having 0%, 1% and 2% nanosilica content, respectively.

FIG. 5 is a table showing free water percentages for Portland Saudi cement type-G with nanosilica additive for high pressure-high temperature applications according to the present invention for cement slurries having 0%, 1% and 2% nanosilica content, respectively.

FIG. 6 is a table showing cement slurry viscosity at different rotational speeds (rpm) for Portland Saudi cement type-G with nanosilica additive for high pressure-high temperature applications according to the present invention for cement slurries having 0%, 1% and 2% nanosilica content, respectively.

FIG. 7 is a table showing plastic viscosity (PV) and yield point (YP) for Portland Saudi cement type-G with nanosilica additive for high pressure-high temperature applications according to the present invention for cement slurries having 0%, 1% and 2% nanosilica content, respectively.

FIG. 8 is a graph showing a shear rate/shear stress diagram for Portland Saudi cement type-G with nanosilica additive for high pressure-high temperature applications according to the present invention for cement slurries having 0%, 1% and 2% nanosilica content, respectively.

FIG. 9 is a table showing compressive strength values for Portland Saudi cement type-G with nanosilica additive for high pressure-high temperature applications according to the present invention for cement slurries having 0%, 1% and 2% nanosilica content, respectively.

FIG. 10 is a table showing development of compressive strength with time for Portland Saudi cement type-G with nanosilica additive for high pressure-high temperature applications according to the present invention for cement slurries having 0%, 1% and 2% nanosilica content, respectively.

FIG. 11 is a graph showing the time required to reach 50 and 500 (Psi) compressive strength for Portland Saudi cement type-G with nanosilica additive for high pressure-high temperature applications according to the present invention for cement slurries having 0%, 1% and 2% nanosilica content, respectively.

FIG. 12 is a graph showing static gel strength development with time for Portland Saudi cement type-G with nanosilica additive for high pressure-high temperature applications according to the present invention for cement slurries having 0%, 1% and 2% nanosilica content, respectively.

FIG. 13 is a table showing development of compressive strength with time and cement slurry transition period for Portland Saudi cement type-G with nanosilica additive for high pressure-high temperature applications according to the present invention for cement slurries having 0%, 1% and 2% nanosilica content, respectively.

FIG. 14 is a table showing densities for Portland Saudi cement type-G with nanosilica additive for high pressure-high temperature applications according to the present invention for cement slurries having 0%, 1% and 2% nanosilica content, respectively.

FIG. 15 is a table showing results of the particles settling test at different depths for Portland Saudi cement type-G with nanosilica additive for high pressure-high temperature applications according to the present invention for cement slurries having 0%, 1% and 2% nanosilica content, respectively.

FIG. 16 is a table showing expansion of the cement samples for Portland Saudi cement type-G with nanosilica additive for high pressure-high temperature applications according to the present invention for cement slurries having 0%, 1% and 2% nanosilica content, respectively.

Similar reference characters denote corresponding features consistently throughout the attached drawings.

### DETAILED DESCRIPTION OF THE PREFERRED EMBODIMENTS

The Portland Saudi cement type-G for high pressure-high temperature applications of the present invention comprises a mixture of: about 2% by cement weight of nanoparticles of silica; and type-G Portland Saudi cement forming the balance of the mixture. The cement so formed is suitable for use in petroleum wells, which require cement that can be introduced under high temperature and high temperature conditions.

Cement lab testing is an important process used to evaluate and develop different properties of the cement system, and to attempt to mimic the actual behavior of the cement in high pressure high temperature downhole environment.

The experiments of this invention are implemented according to the American Petroleum Institute (API) procedures. See American Petroleum Institute, Specification for Materials and Testing for Well Cements, API Spec. 10, 1990, 5^{th} Ed., Washington, D.C.: American Petroleum Institute.

The experiments described herein include several cement tests that address certain cement properties. The cement properties considered are (a) Thickening time; (b) Fluid loss; (c) Free water separation; (d) Rheological properties; (e) Compressive strength, including (1) Compressive strength by “crushing”, and (2) Compressive strength by “sonic waves”; (f) Static gel strength; (g) Density; (h) Particles settling; and (i) Shrinkage/Expansion. The effect of Nanosilica on these cement properties will be investigated.

A typical well in Saudi Arabia is selected having the following specifications: (a) Job Type: cementing 7″ liner; (b) Depth: 14,000 feet; (c) Bottom hole circulating temperature (BHCT): 228° F.; (d) Bottom hole static temperature (BHST): 290° F.; (e) Time to reach bottom (TRB): 49 minutes; (f) Surface pump pressure: 1050 Psi; (g) Mud Weight: 85 PCF; and (h) Bottom hole pressure: 8265 Psi; (h)

The selected well has a special cement system, since the well is deep, with high pressure and temperature conditions. The cement system consists of different materials that contribute chemical and physical properties to make the cementing job successful.

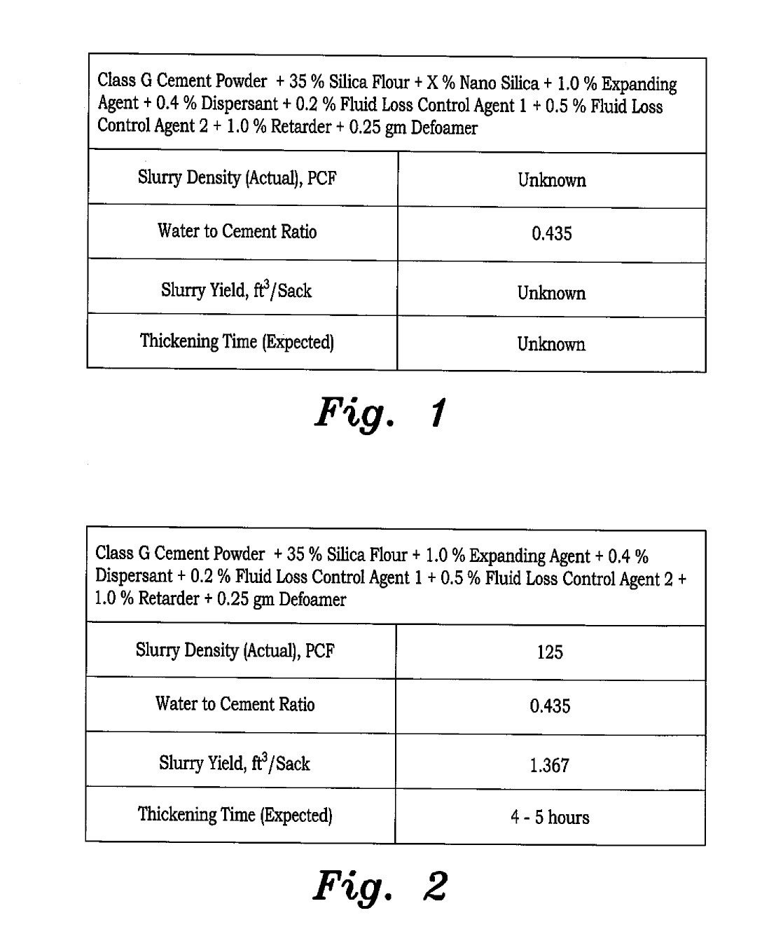

The table in FIG. 1 contains the materials of the cement slurry design with the addition of the nanosilica material, where X in FIG. 1 represents nanosilica percentages by cement weight.

The table in FIG. 2 contains the materials of the cement slurry design without the addition of the nanosilica material. This cement slurry system will be processed through a series of cement tests in the experimental program to obtain results that will be considered as the base case to be referred to.

Cement tests, purpose, testing apparatus and procedures are described as follows. A Thickening Time Test was performed. The purpose of this test is to determine the time the cement slurry will reach 100 Bearden unit of consistency (BC), which is considered the length of time the slurry remains pumpable. The testing apparatus includes a pressurized consistometer, which is the most commonly used machine to determine the thickening time of the cement slurry while it is being stirred under high pressure and temperature conditions. The procedure includes the following: (1) A mixing jar is filled with normal tap water; (2) Cement powder is mixed with silica products separately; (3) The chemical additives are added to the water in the mixing jar at low mixing speed; (4) The cement powder mixture is then added to the water and chemical additives at a mixing speed of 4,000 rpm within 3 minutes; (5) The final mixture is then mixed further at 12,000 rpm for 35 seconds; (6) The slurry is poured into the consistometer slurry cell and placed inside the machine to be stirred at 150 rpm, 228° F., and 9,315 Psi; and (7) Slurry consistency is monitored and the time to reach consistency of 100 BC is recorded.

A Fluid Loss Test is also performed. The purpose of this test is to determine the amount of fluid loss from the slurry under high pressure and temperature conditions. The testing apparatus is a high pressure-high temperature cement slurry fluid loss tester. The procedure includes the following: (1) A mixing jar is filled with normal tap water; (2) Cement powder is mixed with silica products separately; (3) The chemical additives are added to the water in the mixing jar at a low mixing speed; (4) The cement powder mixture is then added to the water and chemical additives at a mixing speed of 4,000 rpm within 3 minutes; (5) The final mixture is then mixed further at 12,000 rpm for 35 seconds; (6) The slurry is conditioned for 20 minutes at 194° F. and atmospheric pressure; (7) The slurry is taken to the high pressure-high temperature fluid loss tester 1 to be tested under 1,000 Psi and 194° F. for 30 minutes; and (8) The amount of collected fluid loss is measured.

A Free Water Separation Test is also performed. The purpose of this test is to determine the amount of free water that forms on top of the cement slurry column after a certain period of aging time. The testing apparatus is a graduated cylinder. The procedure includes the following: (1) A mixing jar is filled with normal tap water; (2) Cement powder is mixed with silica products separately; (3) The chemical additives are added to the water in the mixing jar at a low mixing speed; (4) The cement powder mixture is then added to the water and chemical additives at a mixing speed of 4,000 rpm within 3 minutes; (5) The final mixture is then mixed further at 12,000 rpm for 35 seconds; (6) The slurry is conditioned for 20 minutes at 194° F. and atmospheric pressure; (7) The slurry is carefully poured into a graduated cylinder; (8) Aluminum foil is used to cover the top of the cylinder and the slurry is aged for 2 hours; and (9) The free water separated is drained using a syringe and the percentage of free water is calculated.

A Rheology Test is also performed. The purpose of this test is to determine different rheological properties, such as viscosity and yield point of the cement slurry under high temperature condition. The testing apparatus is the most commonly used equipment to measure the rheological properties, namely, the variable speed rheometer. The procedure includes the following: (1) A mixing jar is filled with normal tap water; (2) Cement powder is mixed with silica products separately; (3) The chemical additives are added to the water in the mixing jar at a low mixing speed; (4) The cement powder mixture is then added to the water and chemical additives at a mixing speed of 4,000 rpm within 3 minutes; (5) The final mixture is then mixed further at 12,000 rpm for 35 seconds; (6) The slurry is conditioned for 20 minutes at 194° F. and atmospheric pressure; (7) The slurry is poured into the rheometer cup that was preconditioned at 194° F.; (8) The slurry is stirred for about 10 seconds at 300 rpm, 200 rpm, 100 rpm, 6 rpm, and 3 rpm; and (9) Viscosity readings are recorded at every speed.

Compressive Strength Tests are also performed. The purpose of these tests is to determine the cement capacity to withstand axial pushing forces. Two methods will be employed to determine the cement compressive strength, including a direct method by applying physical force to square inch cement cubes, and an indirect method utilizing ultrasonic waves that the cement slurry will be subjected to.

In the Compressive Strength Test (Crushing Test), the testing apparatus includes the most commonly used machine for compressive strength determination, namely, the API compressive strength tester. The procedure includes the following: (1) A mixing jar is filled with normal tap water; (2) Cement powder is mixed with silica products separately; (3) The chemical additives are added to the water in the mixing jar at a low mixing speed; (4) The cement powder mixture is then added to the water and chemical additives at a mixing speed of 4,000 rpm within 3 minutes; (5) The final mixture is then mixed further at 12,000 rpm for 35 seconds; (6) The cement slurry is carefully poured into molding cubes to make square shape samples (2 inch×2 inch); (7) The sample molds are taken to the High Pressure/High Temperature (HP/HT) curing chamber to be conditioned for 24 hours at 290° F. temperature and 3,000 Psi pressure; (8) Cement samples are taken to the compressive strength tester; and (9) The cement sample will be subjected to gradually increasing axial force until the sample fails and the maximum load applied is recorded.

In the Compressive Strength Test (Ultrasonic Test), the testing apparatus is an Ultrasonic Cement Analyzer (UCA). The procedure includes the following: (1) A mixing jar is filled with normal tap water; (2) Cement powder is mixed with silica products separately; (3) The chemical additives are added to the water in the mixing jar at a low mixing speed (4) The cement powder mixture is then added to the water and chemical additives at a mixing speed of 4,000 rpm within 3 minutes; (5) The final mixture is mixed further at 12,000 rpm for 35 seconds; (6) The slurry is conditioned for 20 minutes at 194° F. and atmospheric pressure; (7) The cement slurry is carefully poured into a special cell before inserting it into the UCA; (8) The UCA is set to bottom hole circulating temperature of 228° F. in the first 49 minutes, and then the temperature increases to bottom hole static temperature of 290° F. and pressure of 4,666 Psi; and (9) The UCA is run for 24 hours and the development of cement sonic strength is monitored.

A Static Gel Strength Test is also performed. The purpose of this test is to determine static gel strength of the cement slurry, which gives an indication of the development of slurry gelation process with time. The testing apparatus is a Static Gel Strength Analyzer (SGSA). The procedure includes the following: (1) A mixing jar is filled with normal tap water; (2) Cement powder is mixed with silica products separately; (3) The chemical additives are added to the water in the mixing jar at a low mixing speed; (4) The cement powder mixture is then added to the water and chemical additives at a mixing speed of 4,000 rpm within 3 minutes; (5) The final mixture is mixed further at 12,000 rpm for 35 seconds; (6) The slurry is conditioned for 20 minutes at 194° F. and atmospheric pressure; (7) The cement slurry is carefully poured into a special cell before inserting it into the SGSA; (8) The SGSA is set to bottom hole circulating temperature of 228° F. in the first 49 minutes, and then the temperature increases to bottom hole static temperature of 290° F. and pressure of 4,666 Psi; and (9) The SGSA is run for 24 hours and the development of cement compressive strength and cement gel strength are monitored. The SGSA testing procedure is similar to the UCA testing procedure, since SGSA gives compressive strength data as well.

Density Measurement is also performed. The purpose of this test is to determine the actual density of the cement slurry under pressure conditions. The testing apparatus is the most commonly used tool to measure the density of any fluid, which is the pressurized density balance. The procedure includes the following: (1) A mixing jar is filled with normal tap water; (2) Cement powder is mixed with silica products separately; (3) The chemical additives are added to the water in the mixing jar at a low mixing speed; (4) The cement powder mixture is then added to the water and chemical additives at a mixing speed of 4,000 rpm within 3 minutes; (5) The final mixture is mixed further at 12,000 rpm for 35 seconds; (6) The density balance is calibrated, and then the cement slurry is poured fully into the density balance cup and sealed carefully; (7) The cement slurry is sealed inside the density balance cup and pressure is applied; (8) The rider is then moved until the bubble in the level glass is centered; and (9) The corresponding density is read and recorded.

A Particles Settling Test is also performed. The purpose of this test is to determine cement particles settling that could take place by means of density segregation. The testing apparatus includes special long cells that are used to allow the cement particles settling effect to take place over a certain aging period of time. The procedure includes the following: (1) A mixing jar is filled with normal tap water; (2) Cement powder is mixed with silica products separately; (3) The chemical additives are added to the water in the mixing jar at a low mixing speed; (4) The cement powder mixture is then added to the water and chemical additives at a mixing speed of 4,000 rpm within 3 minutes; (5) The final mixture is then mixed further at 12,000 rpm for 35 seconds; (6) The slurry is conditioned for 20 minutes at 194° F. and atmospheric pressure; (7) The cement slurry is carefully poured into the long cells that are preheated at 194° F.; (8) The cells are taken to the High Pressure/High Temperature (HP/HT) curing chamber to be conditioned for 24 hours at 290° F. temperature and 3,000 Psi pressure; (9) The cement samples are extracted from the cells and cut into three pieces (top, middle, and bottom) for density segregation measurements; (10) Cement pieces (top, middle, and bottom) are weighed before and after immersing in water and the difference is noted; and (11) Density segregation is calculated.

A Shrinkage/Expansion Test is also performed. The purpose of this test is to determine cement shrinkage or expansion phenomena that could take place after cement aging in a high pressure and temperature environment. The testing apparatus includes shrinkage/expansion ring molds. The procedure includes the following: (1) A mixing jar is filled with normal tap water; (2) Cement powder is mixed with silica products separately; (3) The chemical additives are added to the water in the mixing jar at a low mixing speed; (4) The cement powder mixture is then added to the water and chemical additives at a mixing speed of 4,000 rpm within 3 minutes; (5) The final mixture is then mixed further at 12,000 rpm for 35 seconds; (6) The metallic ring molds are prepared to be filled with the slurry; (7) The cement slurry is filled carefully into the ring molds using the appropriate syringe; (8) The distance between the ring mold terminals is measured and will be used as the reference for any expansion or shrinkage that could occur after aging; (9) The ring molds are then taken to the HP/HT curing chamber to be conditioned for 168 hours (7 days) at 290° F. and 3,000 Psi; (10) After 168 hours, the ring molds are taken out of the curing chamber, the distance between the ring mold terminals is measured again, and the difference between the two measurements (after aging—before aging) is noted; and (11) A positive difference indicates expansion, while a negative difference indicates shrinkage.

The following general observations for the proposed nanosilica percentages of the selected well cement system have been noticed. Cement slurry design without the nanosilica (FIG. 2) was easy to implement in the lab and the slurry mixture was easy to condition, test, and clean. Cement slurry design with the nanosilica (FIG. 1) was more challenging than the slurry design without the nanosilica addition. The presence of nanosilica affected the cement physical properties. The more nanosilica that is added, the more thixotropic the slurry was. Thixotropy is the property of cement slurry to develop high gel after a short static period of time. The cement slurry design having a nanosilica percentage of 1% (FIG. 1) was successful and was selected for further testing. The cement slurry design having a nanosilica percentage of 3% (FIG. 1) wasn't successful, as the slurry materials were difficult to mix and will not be considered further.

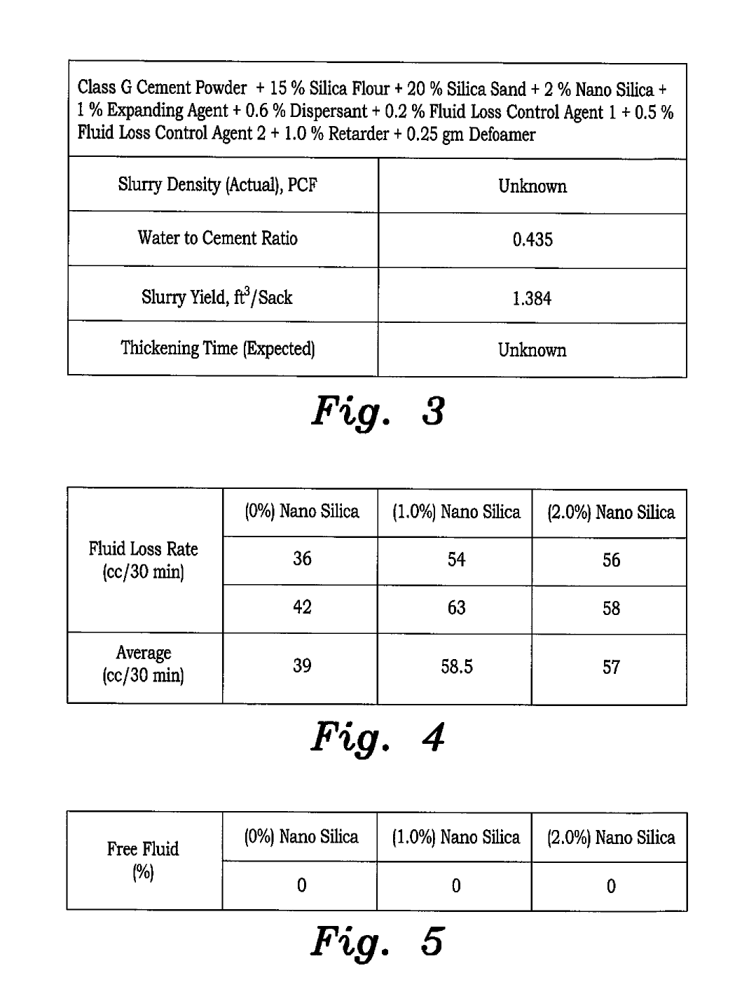

After several unsuccessful attempts, changes had to be considered to the cement system presented in FIG. 1 for the nanosilica percentage of 3%. These changes include increasing the percentage of the dispersant from 0.4% to 0.8% and 1.0%. Moreover, silica sand was introduced, which has a larger particle size and the ability to make the slurry thinner. The slurry could be mixed with difficulty. However, it was too thick (un-pumpable) to be tested, which implies that it reached the maximum limit of nanosilica percentage to be used. It was realized that the cement system having 3.0% and 5.0% nanosilica would not work. Thus, the nanosilica percentage was reduced to 2.0%. The cement slurry design having a nanosilica percentage of 2.0% (FIG. 1) was too thick for testing and needed an increase in the percentage of the dispersant from 0.4% to 0.6% and the addition of silica sand. Therefore, the cement system design having 2.0% nanosilica was as shown in FIG. 3. It is thought that nanosilica content between 2.0% and 3.0% may be practical under similar conditions as 2.0% nanosilica content, but about 3% is the practical upper limit.

Thickening time is an important property of cement slurry and gives an indication of how long the cement slurry remains pumpable. The three cement systems having nanosilica percentages of 0%, 1.0%, and 2.0% were subjected to a thickening time test and times of cement slurries to reach a consistency of 100 BC were recorded. The three slurries had consistencies of 31, 40 and 59 BC at the beginning of the test which is an indication of the condition of the slurry viscosity once prepared. Temperature plays a role in reducing the consistency to some extent at the beginning of the test before it rises again dramatically. Once a consistency of 100 BC is reached, the slurry is considered un-pumpable.

According to the literature, nanosilica has the tendency to decrease the thickening time or accelerate the hydration process of the cement slurry. This effect was observed here, in particular for the cement slurry having a nanosilica percentage of 2.0%. The slurry thickened faster and reached a consistency of 100 BC in almost 4 hours while the other cement slurries having a nanosilica percentage of 0% and 1.0% reached a consistency of 100 BC in more than 6 hours.

The cement slurry having a nanosilica percentage of 1.0% did not suffer from any reduction in thickening time. This could be due to the presence of silica flour at a high percentage (35%), which minimized the effect of nanosilica on the hydration process. However, in the cement slurry having a nanosilica percentage of 2.0%, the silica flour percentage was reduced to 15% and a silica sand percentage of 20% was introduced due to cement slurry preparation concerns. This allowed the nanosilica to have an effect on the hydration process.

Cement slurry fluid loss is another important property used to determine how much fluid is lost when the slurry is exposed to a differential pressure. This could occur when cementing across high permeability zones, deep liners, or sensitive formations. For the well selected in these experiments, a deep liner at a depth of 14,000 ft requires a cement slurry having an acceptable fluid loss rate. The industry has accepted a fluid loss rate for cementing deep liners in the range of 100 cc/30 min.

The three cement systems having nanosilica percentages of 0%, 1.0% and 2.0% were subjected to a fluid loss test for 30 minutes under a pressure of 1,000 Psi at a temperature of 194° F. FIG. 4 shows the results of the fluid loss test. Unlike what has been reported in the literature, nanosilica tended to increase the cement slurry fluid loss rate, even though it did not exceed the acceptable range set by industry. This could be due to the presence of different material particle sizes (Portland cement, silica flour, silica sand and nanosilica), which influences the particles bonding and distribution.

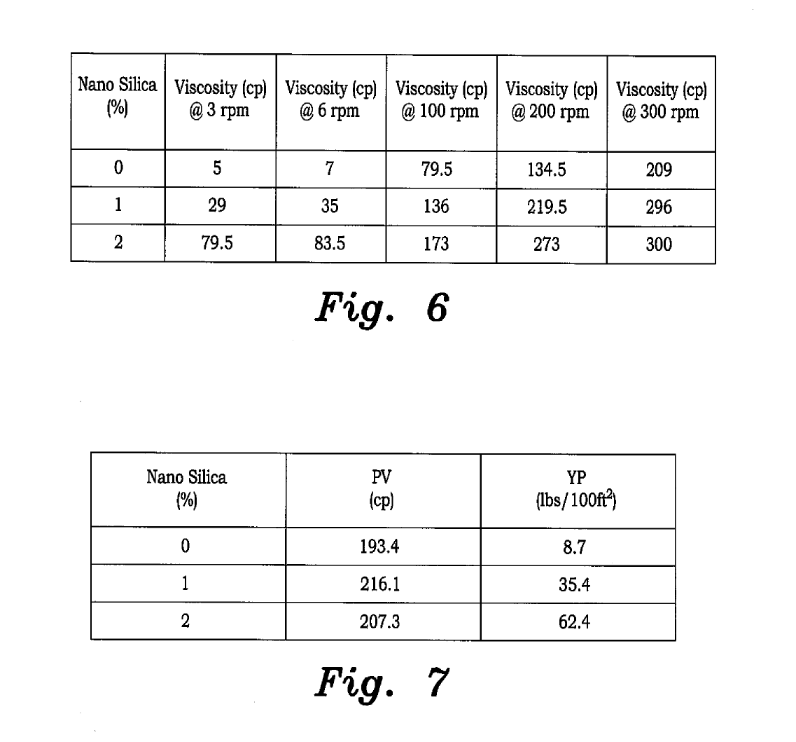

Water is used in cement slurry design to provide fluidity and to act as a chemical agent in the hydration process. However, if water is used excessively, free water might form on top of the cement, while a particles settling effect could take place. To determine the effect of nanosilica on the amount of free water in the cement slurry, the three cement systems having nanosilica percentages of 0%, 1.0% and 2.0% were subjected to free water tests where they were aged for 2 hours under normal room temperature and atmospheric pressure. The results shown in FIG. 5 indicate that the three cement systems showed no water formation and nanosilica did not introduce any disturbance to the particles suspension in the cement slurry.

Cement rheology is an important factor that yields important information which aids in the design of the cementing operation. Cement slurry rheological property measurements give an estimation of the frictional pressure losses and the pumping power requirement during the cementing operation. Rheological properties include determining the cement slurry viscosity at different rotational speeds (rpm), and from that the plastic viscosity and yield point can be determined.

Viscosity is defined as the resistance of a fluid to flow and is measured as the ratio of shear rate to the shear stress. Plastic viscosity is the slope of the shear stress/shear rate curve and the yield point is the shear stress when the shear rate is zero. The three cement systems having nanosilica percentages of 0%, 1.0% and 2.0% were subjected to rheology test and the results are tabulated in FIG. 6. FIGS. 7 and 8 clearly show the effect of nanosilica on the rheological properties of the cement slurry as both plastic viscosity and yield point increased with the increase of nanosilica percentage added to the cement slurry. This can make the nanosilica act as a viscofier agent. However, it should be used with caution, since nanosilica affects other cement slurry properties as well.

Cement compressive strength is a major consideration when performing cementing operations. Pumping the cement efficiently, placing it safely on time, assuring cement integrity after placement (prior to resuming drilling operations) are all issues to be considered. Therefore, compressive strength tests are conducted to obtain an estimation of the development of cement strength with time utilizing the ultrasonic cement analyzer (UCA) and also to determine cement bonding stability after set utilizing the conventional compressive strength test (crushing test).

The three cement systems having nanosilica percentages of 0%, 1.0% and 2.0% were subjected to the API compressive strength test where six cement cubes were prepared for each cement system. The cubes were subjected to an axial increasing load in the compressive strength tester until they cracked.

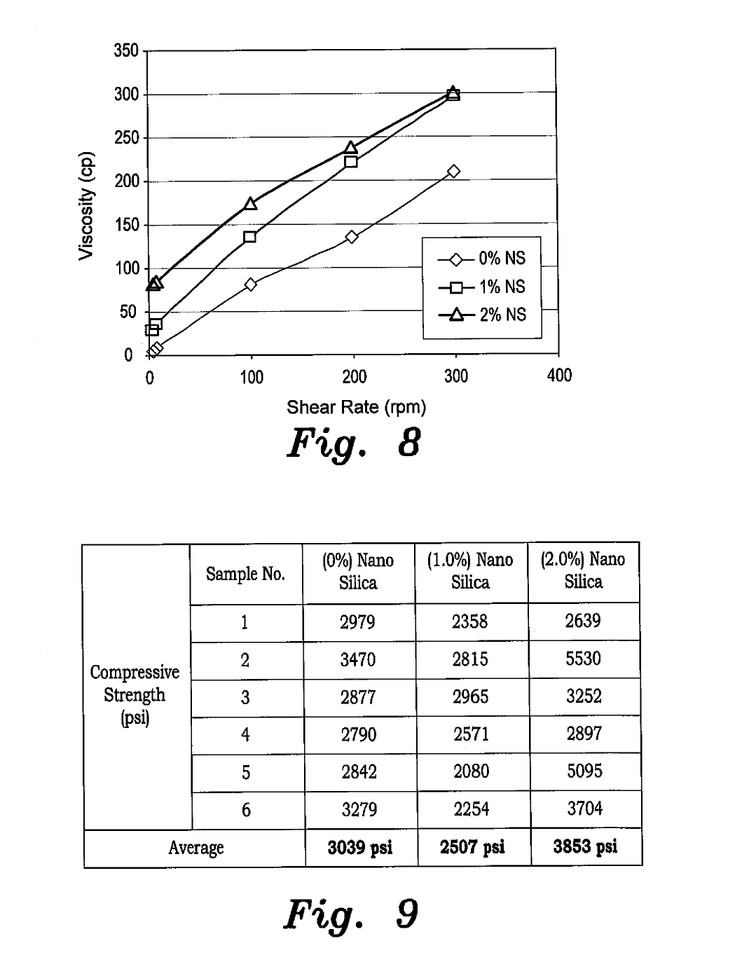

The table in FIG. 9 summarizes the results of the compressive strength test. The compressive strength values in FIG. 9 showed inconsistency, since each cement system has a range of compressive strength values. On average, all three cement systems met industry requirement of achieving a minimum compressive strength of 500 Psi needed after cement set, and prior to resuming the drilling operation. Moreover, all three cement systems met the industry requirement of achieving a minimum strength of 2,000 Psi needed to withstand perforation shots without causing damage to the cement.

According to the literature, nanosilica tends to increases the compressive strength of cement. This occurred in the cement system having a nanosilica percentage of 2.0%, since it yielded high compressive strength values compared to the other two cement systems.

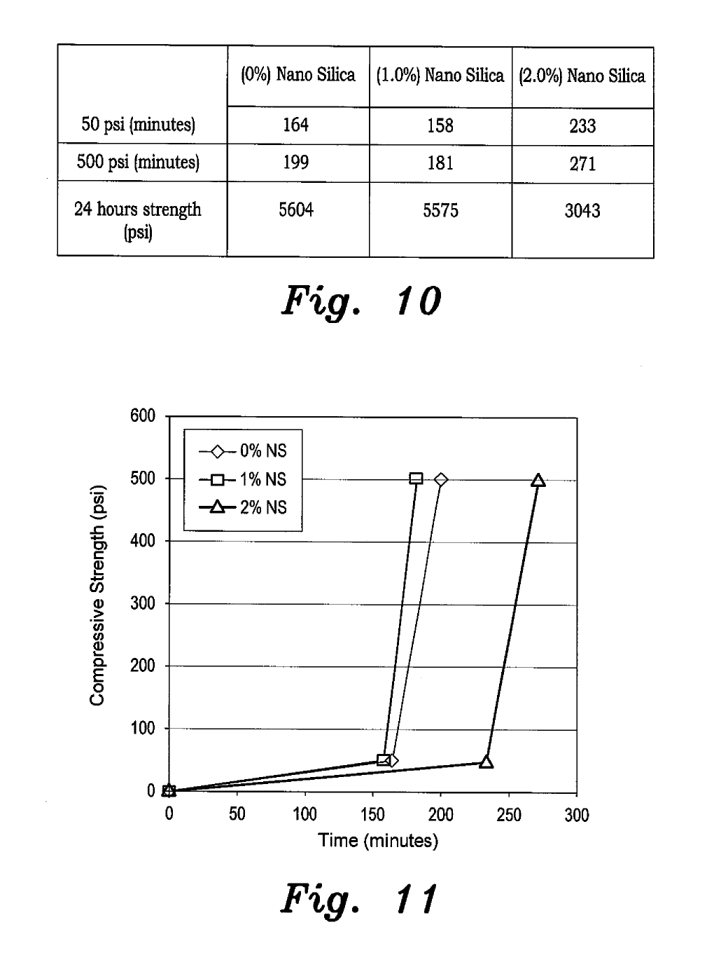

FIG. 10 represents cement slurry development with time. It shows the time required for each cement system to develop a compressive strength of 50 Psi and 500 Psi. These compressive strength values are considered sufficient enough to support the steel casing/liner prior to resuming the drilling operation. The transition period between developing a compressive strength of 50 Psi and 500 Psi is important and needs to be as short as possible to avoid long waiting times for the cement to set before resuming the drilling operation. The cement slurry having nanosilica percentage of 1.0% yielded the shortest transition period of 23 minutes, while the cement slurry having nanosilica percentage of 0% and 2.0% yielded transition periods of 35 minutes and 38 minutes, respectively. FIG. 11 also shows the time required to reach 50 Psi and 500 Psi compressive strength for the cement slurries having 0%, 1.0% and 2.0% nanosilica

Note that compressive strength values obtained from the UCA may not agree with the ones obtained from the crushing test, which is the case in these experiments. The crushing test yields more realistic results. However, this does not represent downhole conditions in the sense of confining pressure and temperature. UCA does subject the cement to high pressure and temperature, but the fact that compressive strength obtained from UCA is correlated out of the transit time measurement makes it uncertain. Therefore, compressive strength values obtained from the UCA must be used with caution.

Cement slurry static gel strength is an important property to be considered when performing cementing operations. Static gel strength is analyzed experimentally utilizing the static gel strength analyzer (SGSA). The SGSA test reveals the static gel strength development process with time in which cement slurry transition period is obtained. The transition period is defined as the period in which the slurry will develop gel strength from 100 lbs/100 ft² to 500 lbs/100 ft² and will start changing from a fluid state into a solid state. This transition must occur when the slurry has reached its destination (e.g., behind the casing/liner) to prevent any possibility of gas migration. The three cement systems having nanosilica percentages of 0%, 1.0%, and 2.0% were subjected to the SGSA test under high temperature (290° F.) and pressure (4,666 Psi) for 24 hours.

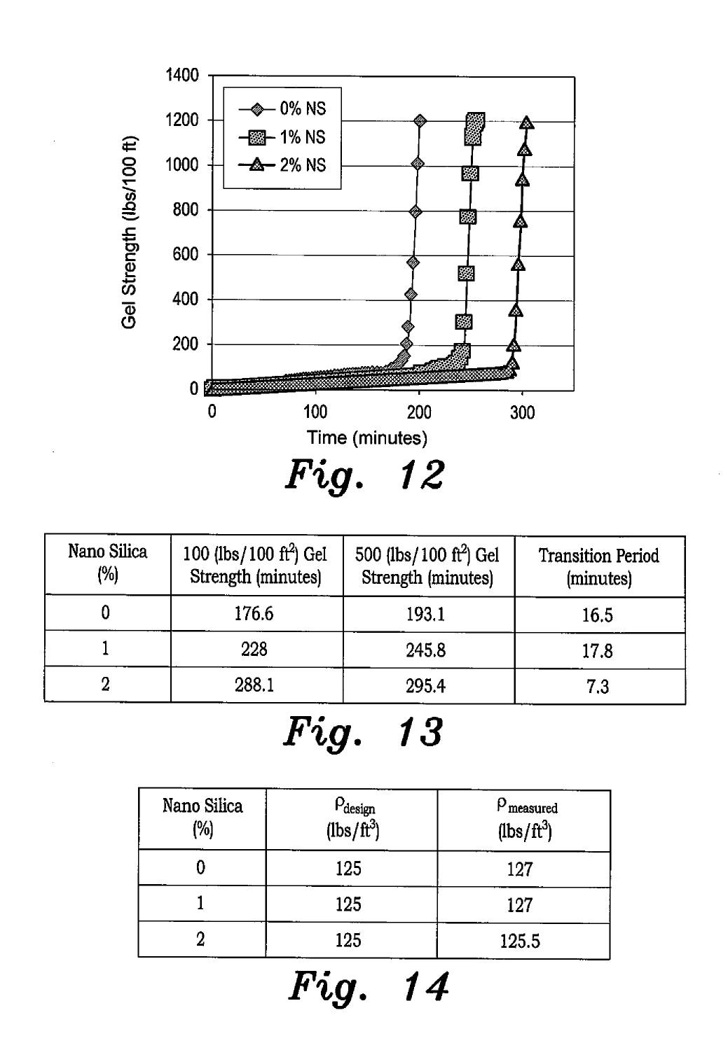

FIG. 12 shows the static gel strength development process for the three cement systems having nanosilica percentages of 0%, 1.0%, and 2.0%. It is evident that nanosilica has a direct effect on the static gel strength, since it caused a delay in the gelation process. Moreover, FIG. 13 shows another effect of nanosilica in terms of reduction in the transition period for the cement slurry having a nanosilica percentage of 2.0%.

Cement slurry density is important for well control consideration. The designed cement slurry density for the selected well is 125 Pcf. However, the actual density needs to be measured in the lab utilizing the pressurized density balance. The densities for the three cement systems having nanosilica percentages of 0%, 1.0%, and 2.0% were measured, and the results are tabulated in FIG. 14. According to the literature, silica is considered a lightening agent, and nanosilica has been reported to decrease slurry density. This was not evident in these experiments, since the cement slurries having nanosilica percentages of 0% and 1.0% did not suffer from density degradation due to the presence of silica flour (35%), which again minimized the effect of nanosilica. On the other hand, the effect on cement slurry having a nanosilica percentage of 2.0% was minimal. It should be noted that the density values reported here are subject to human measurement skills, as well as density balance calibration accuracy.

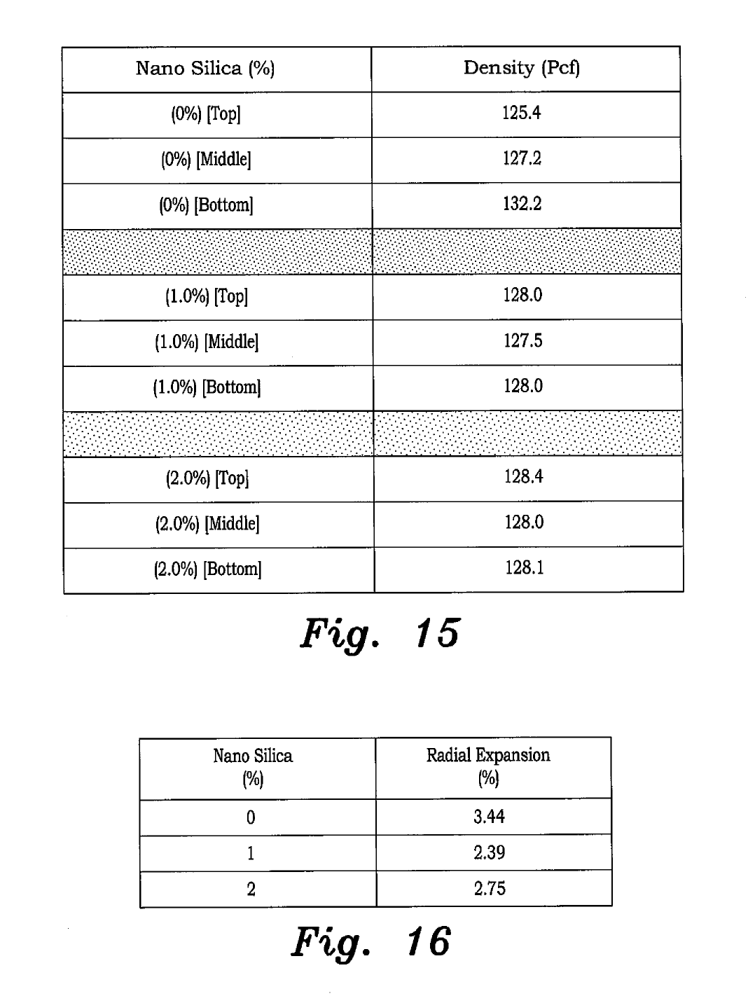

Cement particles settling is a phenomena that may occur in the cement after placement. Density segregation across the cement column is a consequence of the particles settling which is influenced by the suspension property of the cement slurry. The three cement systems having nanosilica percentages of 0%, 1.0%, and 2.0% were subjected to particles settling test where the cement sample is cut into 3 pieces (top, middle, and bottom). The test results are shown in FIG. 15. The results indicated that the density segregation took place in the cement sample having nanosilica percentage of 0%, since density difference was noted from top (125.4 Pcf) to bottom (132.2 Pet) of the cement sample. On the other hand, the other two cement samples having nanosilica percentages of 1.0% and 2.0% exhibited good suspension capability for the cement sample particles.

Cement expansion/shrinkage is a major consideration after cement placement. It is desirable to have cement expansion in the annular space between the steel casing/liner and the formation to allow the cement slurry to fill the small voids in the formation and to present any path that might be created in the case of cement causing fluid movement behind casing or gas migration behind the liner.

The three cement systems having nanosilica percentages of 0%, 1.0%, and 2.0% were subjected to cement shrinkage/expansion test for 168 hours (7 days) at 290° F. temperature and 3,000 Psi pressure. Radial expansions are calculated for each cement sample and shown in FIG. 16. All cement samples exhibited expansion after 7 days of aging under temperature and pressure, indicating that nanosilica did not cause shrinkage of the cement or have an adverse effect on the expanding additive. It should be noted that the three cement systems had the same amount of expanding additive (1.0%).

Conclusions reached from the experiments are as follows. It was evident from the thickening time test that nanosilica acts as an accelerator agent to the cement hydration process, since it shortened the thickening time for the cement slurry having a nanosilica percentage of 2.0%. The fluid loss test indicated that nanosilica tends to increase cement slurry fluid loss rate when mixed with other silica products, such as silica flour and silica sand. This is due to the presence of different particles sizes in the cement slurry. The free water test showed that nanosilica did not cause any free water separation from the cement slurry column after aging. This was noticed in all nanosilica percentages used (0%, 1.0%, and 2.0%). The rheology test proved the ability of nanosilica to increase cement slurry viscosity as the nanosilica percentage increases. This fact can make the nanosilica act as a viscofier agent. However, it should be used with caution, since an excessive increase in nanosilica percentage results in negative effects (un-pumpable slurry).

The compressive strength test (crushing test) showed a growth in the average compressive strength of the cement samples having a nanosilica percentage of 2.0%. The compressive strength test (ultrasonic wave test) revealed the ability of nanosilica to develop compressive strength faster. This was noticeable in the cement sample having a nanosilica percentage of 1.0%. The static gel strength test showed that nanosilica has a direct effect on the static gel strength, since it caused a delay in the gelation process for cement slurries having nanosilica percentage of 1.0% and 2.0%. Moreover, nanosilica reduced the transition period of the cement slurry having a nanosilica percentage of 2.0%. It was not evident from the density test that the nanosilica had a great impact on slurry density, since the cement slurries having nanosilica percentages of 0% and 1.0% did not suffer from density degradation and the effect on the slurry having a nanosilica percentage of 2.0% was minimal. The particles settling test showed the ability of nanosilica to suspend cement particles, which prevents density segregation across the cement column. The cement shrinkage/expansion test showed that the nanosilica did not cause shrinkage of the cement or have an adverse effect on the expanding additive. The presence of silica flour at high percentage in the cement minimized the effect of nanosilica in some tests. The presence of different material particle sizes (cement powder, silica sand, silica flour and nanosilica) affected the tests (UCA and SGSA) that rely on sonic waves transit time. Nanosilica percentages of higher than 2.0% could not be achieved due to difficulties in mixing cement slurry materials.

It is to be understood that the present invention is not limited to the embodiments described above, but encompasses any and all embodiments within the scope of the following claims.

We claim:

1. A cement for use in deep oil wells at temperatures up to 290° F. and pressures between 8,000 and 9,000 psi, the cement comprising a mixture of type-G Portland Saudi cement having a nanoparticle additive, the nanoparticle additive consisting essentially of nanoparticles of silica.

2. The cement according to claim 1, wherein the nanoparticles of silica comprise 1.0% by dry weight of the mixture.

3. A method of protecting a casing in a deep oil well, comprising the steps of:
mixing the cement of claim 2 with water to form a cement slurry; and
hydraulically pumping the slurry into the well bore around the casing.

4. The cement according to claim 1, wherein the nanoparticles of silica comprise 2.0% by dry weight of the mixture, the mixture further comprising silica sand and 0.6% dispersant by dry weight of the mixture.

5. A method of protecting a casing in a deep oil well, comprising the steps of:
mixing the cement of claim 4 with water to form a cement slurry; and
hydraulically pumping the slurry into the well bore around the casing.

6. A Portland Saudi cement type-G, consisting of a mixture of:
Portland Saudi type-G cement powder;
silica flour;
nanosilica;
an expanding agent;
a dispersant;
a fluid loss control agent;
a retarder; and
a defoamer.

7. The Portland Saudi cement type-G of claim 6, wherein:
the silica flour comprises 35% by dry weight of the mixture;
the nanosilica comprises between 1.0% and 2.0% by dry weight of the mixture;
the expanding agent comprises 1.0% by dry weight of the mixture;
the dispersant comprise 0.4% by dry weight of the mixture;
the fluid loss control agent comprises 0.7% by dry weight of the mixture;
the retarder comprises 1.0% by dry weight of the mixture; and
the defoamer comprises 0.25 gm of the mixture;
the balance being the Portland Saudi type-G cement powder.

8. The Portland Saudi cement type-G according to claim 7, wherein the nanosilica consists of 1.0% by dry weight of the mixture.

9. A method of cementing under high pressure-high temperature conditions comprising introducing the Portland Saudi cement type-G as claimed in claim 8 into a well.

10. A Portland Saudi cement type-G, consisting of a mixture of:
Portland Saudi type-G cement powder;
silica flour;
silica sand;
nanosilica;
an expanding agent;
a dispersant;
a fluid loss control agent(s);
a retarder; and
a defoamer.

11. The Portland Saudi cement type-G of claim 10, wherein:
the silica flour comprises 15% by dry weight of the mixture;
the silica sand comprises 20% by dry weight of the mixture;
the nanosilica comprises between 1.0% and 2.0% by dry weight of the mixture the expanding agent comprises 1.0% by dry weight of the mixture;
the dispersant comprise 0.6% by dry weight of the mixture;
the fluid loss control agent comprises 0.7% by dry weight of the mixture;
the retarder comprises 1.0% by dry weight of the mixture; and
the defoamer comprises 0.25 gm of the mixture;
the balance being the Portland Saudi type-G cement powder.

12. The Portland Saudi cement type-G according to claim 11, wherein the nanosilica consists of 2.0% by dry weight of the mixture.

13. A method of cementing under high pressure-high temperature conditions comprising introducing the Portland Saudi cement type-G as claimed in claim 12 into a well.
